(19) United States
(12) Patent Application Publication
(10) Pub. No.: US 2004/0208448 A1
(43) Pub. Date: Oct. 21, 2004

(54) Tunable filter

(76) Inventors: Keisuke Asami, Tokyo (JP); Yoshinori Satoh, Tokyo (JP)

Correspondence Address: FISH & RICHARDSON P.C., 45 ROCKEFELLER PLAZA, SUITE 2800, NEW YORK, NY, 10111, US

(21) Appl. No.: 10/093,986

(22) Filed: Mar. 8, 2002

(30) Foreign Application Priority Data
Mar. 16, 2001 (JP) P. 2001-076742

(51) Int. Cl. G02B 6/26

(52) U.S. Cl. 385/39

(57) ABSTRACT

A tunable filter includes a wavelength selector and a reflector. The wavelength selector selects a wavelength of a light beam. The reflector reflects the light beam, the wavelength of which is selected by the wavelength selector. The light beam reflected by the reflector is again introduced into the wavelength selector to improve wavelength selectivity.

### BACKGROUND OF THE INVENTION

1. Field of the Invention

The present invention relates to a tunable filter used for selectively outputting a light beam having a predetermined wavelength.

2. Description of the Related Art

FIG. 5 is a diagram showing a conventional tunable filter used for selectively outputting a light beam having a predetermined wavelength.

A light beam entered from an input side optical fiber 11 is transmitted through an input condenser 12 to a bandpass filter 13.

The light beam output from the bandpass filter 13 passes through an output condenser 14 to an output optical filter 15.

A dielectric film is coated on the incident surface of the bandpass filter 13, and the thickness of the dielectric film varies in the directions indicated by the double-headed arrow in FIG. 5.

The bandpass filter 13 is so designed to slide in the directions indicated by the double-headed arrow, so that the wavelength of the light to be transmitted is selectable by adjusting the thickness of the dielectric film deposited on the incident surface.

In the conventional tunable filter in FIG. 5, the bandpass filter is slid to-and-fro to select the wavelength of the light beam to be output. However, sufficient wavelength selection cannot be conducted according to this conventional arrangement.

In addition, it might be considered that the number of layer of the bandpass filter is increased in order to improve the wavelength selectivity provided by this conventional arrangement. However, such increase would result in increase of the manufacturing cost therefor.

### SUMMARY OF THE INVENTION

It is an object of the invention to provide at a low cost a tunable filter that provides improved selectivity for a wavelength of the light beam to be output, in order to output a light beam having a narrowed bandwidth.

To achieve the object, according to a first aspect of the invention, provided is a tunable filter at a low cost comprising:

wavelength selection means; and

reflection means, for reflecting transmitted light that is selected by the wavelength selection means,

wherein light reflected by the reflection means is again passed through the wavelength selection means to improve wavelength selectivity.

According to a second aspect of the invention, the wavelength selection means is constituted by a bandpass filter whereon the thickness of the dielectric film deposited varies, and a slide mechanism is provided that slides the bandpass filter in the direction in which the thickness of the dielectric film changes. As a result, further improvement in the selectivity of light having an arbitrary wavelength can be assured.

According to a third aspect of the invention, a double-core fiber, which guides in common light received by the bandpass filter and light output by the bandpass filter, is provided, so that the tunable filter can be more compactly made.

According to a fourth aspect of the invention, an angle adjustment mechanism is provided for adjusting the angle of the bandpass filter in a direction perpendicular to the sliding direction. When a difference exists between a wavelength selected for the first transmission and a wavelength selected for the second transmission, the angle adjustment mechanism adjusts the difference in the selected wavelengths, so that a more accurate wavelength can be selected.

According to a fifth aspect of the invention, the construction of an adjustment mechanism for the tunable filter can be simplified by integrally forming the slide mechanism and the angle adjustment mechanism.

According to a sixth aspect of the invention, the integral assembly of the slide mechanism and the angle adjustment mechanism is provided as caulking means for attaching the bandpass filter to a U-shaped slidable substrate, and for caulking the opening of the U-shaped slidable substrate, so that in the direction perpendicular to the sliding direction the angle of the bandpass filter can be easily adjusted.

### BRIEF DESCRIPTION OF THE DRAWINGS

FIG. 1 is a diagram showing an arrangement of a tunable filter according to the present invention.

FIG. 2 is a diagram showing an arrangement of a tunable filter having an angle adjustment mechanism according to the invention.

FIG. 3 is a diagram for describing a function of the tunable filter that narrows a selected band.

FIG. 4 is a diagram for explaining improvement of the wavelength selectivity for the angle adjustment mechanism of the tunable filter of the invention.

FIG. 5 is a diagram showing an arrangement of a conventional tunable filter.

### DETAIELD DESCRIPTION OF THE PRESENT INVENTION

The present invention will be described with reference to the accompanying drawings.

First Embodiment

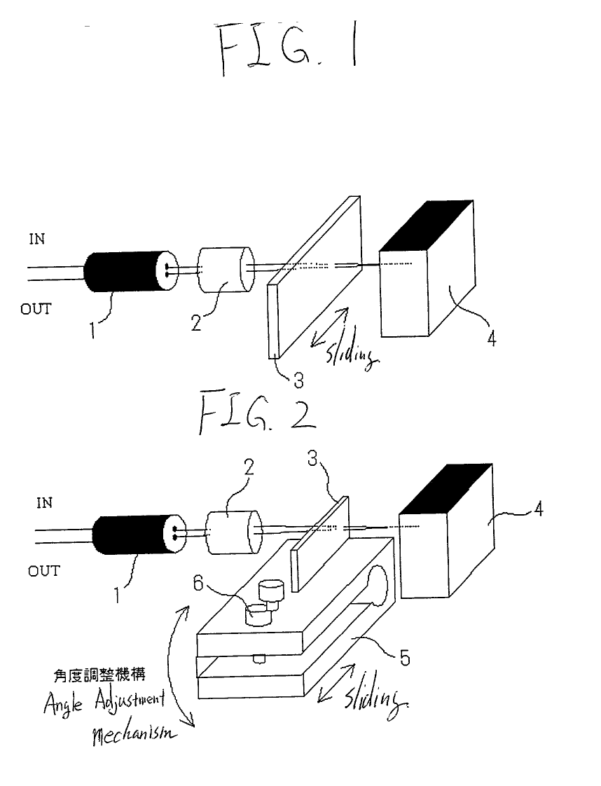

FIG. 1 is a diagram showing the configuration of a tunable filter according to a first embodiment of the invention.

In FIG. 1, a double-core fiber 1 includes an input optical fiber and an output optical fiber.

A condenser 2 is used in common by the input side and the output side, and transmits an input light beam to a bandpass filter 3, while a transmitted light beam received from the bandpass filter 3 to the output optical fiber.

The input optical fiber and the output optical fiber of the double-core fiber 1 are arranged perpendicular to the direction in which the bandpass filter 3 slides.

A dielectric film, the thickness of which continuously varies in directions indicated by arrows in FIG. 1, is applied onto the incident surface of the bandpass filter 3.

The bandpass filter 3 is slidable in the directions indicated by the double-headed arrow in FIG. 1, and the wavelength of the light to be transmitted can be selected by adjusting the thickness of the dielectric film applied onto the incident surface of the bandpass filter 3.

In FIG. 1, a light beam passing through the bandpass filter 3 is reflected by a mirror 4, so that the reflected light again passes through the bandpass filter 3.

Accordingly, the light beam is twice transmitted through the bandpass filter 3, which improves wavelength selectivity or further narrows the bandwidth of the selected wavelength.

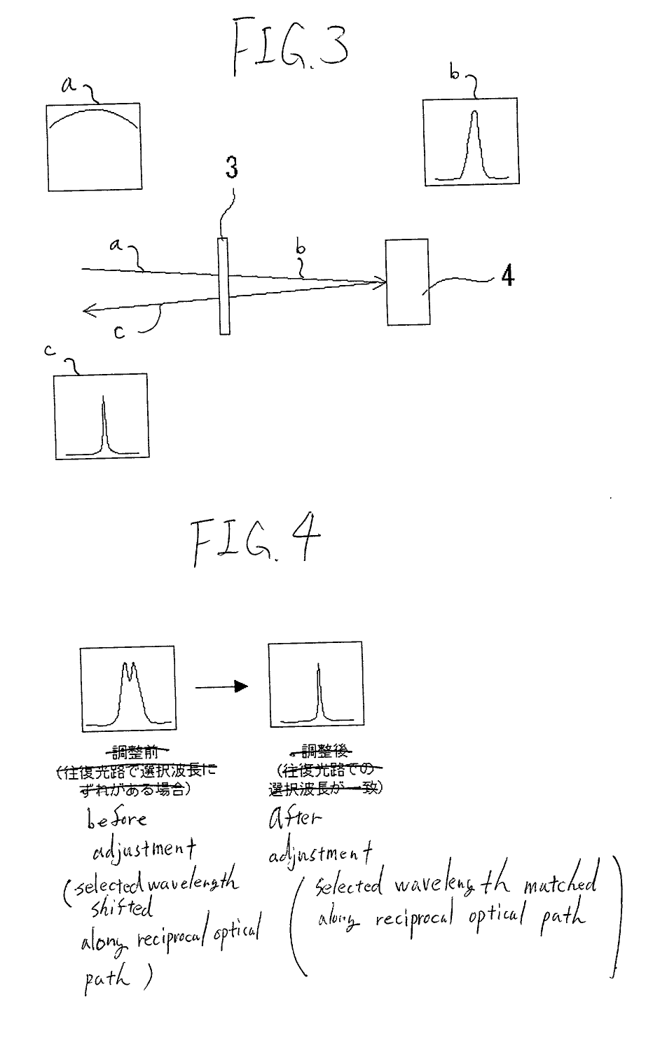

While referring to FIGS. 3A to 3C, a detailed explanation will now be given for the reason that additional narrowing of the bandwidth can be achieved by improving the wavelength selectivity.

In FIG. 3, “a” shows a spectrum of a light beam before wavelength selection by the conventional tunable filter in FIG. 5.

“b” shows a spectrum of a light beam that has been selected and output by the conventional tunable filter in FIG. 5.

Since in the conventional tunable filter in FIG. 5, the input light beam is transmitted through the bandpass filter 3 only once, a large selection range is provided by the bandpass filter 3, and an target light beam having a narrow bandwidth cannot be obtained.

However, according to the tunable filter of the invention, light transmitted through the bandpass filter 3 is reflected by the mirror, and the reflected light passes through the bandpass filter 3 again. Therefore, since the light that is input passes through the bandpass filter 3 twice, as is shown “c” of FIG. 3, an output light beam having a narrow bandwidth can be obtained.

Second Embodiment

FIG. 2 is a diagram showing an arrangement of a tunable filter according to the invention.

In FIG. 2, a double-core fiber 1 includes an input optical fiber and an outptut optical fiber.

A condenser 2 is used in common by the input side and the output side, and transmits an input light beam to a bandpass filter 3 while transmitting the light beam received from the bandpass filter 3 to the output optical fiber.

The input optical fiber and the output optical fiber of the double-core fiber 1 are arranged in a direction perpendicular to the direction in which the bandpass filter 3 slides.

A dielectric film, the thickness of which continuously varies in the directions indicated by a double-headed arrow in FIG. 2, is deposited on the incident surface of the bandpass filter 3.

The bandpass filter 3 is slidable in the directions indicated by the double-headed arrow in FIG. 2, and the wavelength of the light to be transmitted can be selected by adjusting the thickness of the dielectric film applied onto the incident surface of the bandpass filter 3.

In FIG. 2, a light bema is transmitted through the bandpass filter 3 and is reflected by a mirror 4, and the reflected light beam is again passed through the bandpass filter 3.

Since the light is transmitted through the bandpass filter 3 twice, improved wavelength selectivity (narrowing of the bandwidth) can be provided. This is the same as the results obtained for the tunable filter in FIG. 1.

The feature of the second embodiment in FIG. 2 is that the bandpass filter 3 is attached to a U-shaped substrate 5, and the opening of the substrate 5 is secured by a screw 6.

With this arrangement, the bandpass filter 3 attached to the U-shaped substrate 5 can slide in the directions indicated by the arrows, and the angle of the bandpass filter 3 can be adjusted in a direction perpendicular to the sliding direction.

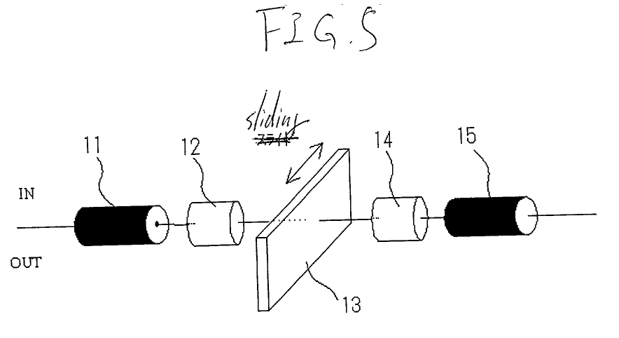

While now referring to FIGS. 4A and 4B, a detailed explanation will be given for the reasons that the bandpass filter 3 can slide in the directions indicated by the arrows and that the angle of the bandpass filter 3 must be adjusted in the direction perpendicular to the direction in which the bandpass filter 3 slides.

FIG. 4 is a diagram showing an image used to explain that the spectrum of input light beam that is selected by the tunable filter of the invention is adjusted by the angle adjustment mechanism.

The left side spectrum of the output light beam shows a state that the angle adjustment mechanism is not used for angle adjustment. A difference exists between the first transmission and the second transmission (the reciprocal light path) of the selected wavelengths.

The right side spectrum of the output light beam shows a state that the angle adjustment mechanism is used for angle adjustment. Between the first transmission and the second transmission (the reciprocal light path), the selected wavelengths match.

Because the thickness of the dielectric film at the location at which the input light passes through the bandpass filter 3 differs from the thickness of the dielectric film at the location at which the light reflected by the mirror 4 passes through again, the output spectrum on the right side has two peaks.

While the thickness of the dielectric film deposited on the bandpass filter 3 continuously varies, for example gradually increases, in the direction in which the bandpass filter 3 slides, dielectric film having the same thickness is deposited on the portion perpendicular to the direction in which the bandpass filter 3 slides.

However, as shown in FIG. 2, when the first transmitted light and the second transmitted light pass through the bandpass filter 3 perpendicularly, between the first and the second transmissions the light passes through dielectric film portions having different thicknesses, so that the selected wavelengths differ.

In this case, the bandpass filter 3 is adjusted by tightening or loosening the screw 6 in FIG. 2, so that at the first and the second transmissions the light passes through portions on the bandpass filter 3 on which dielectric film having the same thickness is deposited. In this manner, the shifting of the selected wavelength is eliminated, and the output light spectrum in FIG. 4B is obtained.

In FIG. 2, two screws 6 are provided. Threads for one of the two screws 6 are provided in the upper plate of the U-shaped substrate, so that by tightening this screw the upper plate of the U-shaped substrate can be moved upward.

Threads for the other screw are provided in the lower plate of the U-shaped substrate, so that by tightening this screw the upper plate of the U-shaped substrate can be moved downward.

When the bandpass filter 3 is attached, the two screws 6 are adjusted and tightened, to eliminate the shifting of the selected wavelength is removed, and are fixed in position.

The angle adjustment mechanism for the U-shaped substrate, however, is not limited to this example.

During the adjustment process, the positioning of the condenser 2, the bandpass filter 3 and the mirror 4 is fixed, and the attachment location of the double-core fiber is adjusted, so that the input optical fiber and the output optical fiber of the double-core fiber are secured in the direction perpendicular to the direction in which the bandpass filter 3 slides, and parallel light is reflected by the mirror 4 and is focused on the output optical fiber. For this, a broadband light source having a high output is preferably employed.

Then, control of the angle adjustment mechanism of the bandpass filter 3 is exercised to obtain the narrowest possible bandwidth.

An error in the attachment of the bandpass filter 3 may be one of the reasons that an angle is formed between the first light and the second light transmitted through the bandpass filter 3.

Further, this angle adjustment mechanism can also be used for the arrangement in FIG. 2, wherein the input optical fiber and the output optical fiber of the double-core fiber that is employed are not precisely perpendicularly arranged.

A double-core fiber has been employed in the explanation for the tunable filters shown in FIGS. 1 and 2. However, by the addition of an input optical fiber and a condenser, an output optical fiber and a condenser can be also employed.

To achieve the object of the invention, according to the first aspect of the invention, provided is a tunable filter at a low cost comprising:

the wavelength selection means; and

the reflection means, for reflecting transmitted light that is selected by the wavelength selection means,

wherein light reflected by the reflection means is again passed through the wavelength selection means to improve wavelength selectivity.

According to the second aspect of the invention, the wavelength selection means is constituted by a bandpass filter whereon the thickness of the dielectric film deposited varies, and a slide mechanism is provided that slides the bandpass filter in the direction in which the thickness of the dielectric film changes. As a result, further improvement in the selectivity of light having an arbitrary wavelength can be assured.

According to the third aspect of the invention, a double-core fiber, which guides in common light received by the bandpass filter and light output by the bandpass filter, is provided, so that the tunable filter can be more compactly made.

According to the fourth aspect of the invention, an angle adjustment mechanism is provided for adjusting the angle of the bandpass filter in a direction perpendicular to the sliding direction. When a difference exists between a wavelength selected for the first transmission and a wavelength selected for the second transmission, the angle adjustment mechanism adjusts the difference in the selected wavelengths, so that a more accurate wavelength can be selected.

According to the fifth aspect of the invention, the construction of an adjustment mechanism for the tunable filter can be simplified by integrally forming the slide mechanism and the angle adjustment mechanism.

According to the sixth aspect of the invention, the integral assembly of the slide mechanism and the angle adjustment mechanism is provided as caulking means for attaching the bandpass filter to a U-shaped slidable substrate, and for caulking the opening of the U-shaped slidable substrate, so that in the direction perpendicular to the sliding direction the angle of the bandpass filter can be easily adjusted.

What is claimed is:

1. A tunable filter comprising:
a wavelength selector for selecting a wavelength of a light beam; and
a reflector for reflecting the light beam, the wavelength of which is selected by the wavelength selector,
wherein the light beam reflected by the reflector is again introduced into the wavelength selector to improve wavelength selectivity.

2. The tunable filter according to claim 1, wherein the wavelength selector is formed of a bandpass filter including a dielectric film having a thickness continuously changing in a direction; and
wherein the wavelength selector includes a slide mechanism for sliding the bandpass filter in the direction in which the thickness of the dielectric film changes.

3. The tunable filter according to claim 1, further comprising:
a double-core fiber for guiding in common the light beam to be received by the wavelength selector and the light beam to be output from the bandpass filter.

4. The tunable filter according to claim 2, further comprising:
an angle adjustment mechanism for adjusting the angle of the bandpass filter in a direction perpendicular to the sliding direction.

5. The tunable filter according to claim 4, wherein the slide mechanism and the angle adjustment mechanism are integrally formed.

6. The tunable filter according to claim 5, wherein the bandpass filter is disposed onto a U-shaped slidable substrate;
the U-shaped slidable substrate has the integral assembly of the slide mechanism and the angle adjustment mechanism; and
the opening of the U-shaped slidable substrate is caulked, so that the angle of the bandpass filter is adjusted in the direction perpendicular to the sliding direction.
